(19) United States
(12) Patent Application Publication
(10) Pub. No.: US 2012/0331051 A1
(43) Pub. Date: Dec. 27, 2012

(54) SYSTEM AND METHOD FOR DESIGNING AND MANAGING SOCIAL MEDIA CAMPAIGNS

(76) Inventors: Santanu Bhattacharya, Bangalore, Karnataka (IN); Subhashini Naidu, Bangalore (IN); Devesh Meena, Bangalore (IN); Ramanathan Rm, Bangalore (IN)

(21) Appl. No.: 13/241,929

(22) Filed: Sep. 23, 2011

(30) Foreign Application Priority Data
Sep. 25, 2010 (IN) 2821/CHE/2010

(51) Int. Cl. G06F 15/16

(52) U.S. Cl. 709/204

(57) ABSTRACT

In one embodiment, a system for designing and managing one or more social media campaigns is described. The system comprises at least one client capable of providing a user, access to a plurality of social media channels, a server communicatively coupled to the at least one client through a network, the server configured to extract user information from the at least one client, a demand side configured to be accessed by a marketer, a supply side configured to be accessed by the plurality of social media channels and a social media exchange platform configured to enable exchange of data between the demand side and the supply side. Method for designing and managing the social media campaigns is also disclosed.

### CROSS-REFERENCE TO RELATED APPLICATION

The present application claims priority under 35 U.S.C. 119(a) to India (IN) patent application number 2821/CHE/2010 filed Sep. 25, 2010, which IN patent application is incorporated herein by reference in its entirety.

### BACKGROUND OF THE INVENTION

1. Field of the Invention

The invention generally relates to social media. More specifically, the invention relates to managing social media campaigns.

2. Description of the Prior Art

In the Internet age of today, social media channels are an important medium for running promotional campaigns for brands, products, and services. Examples of social media channels may include, but are not limited to, social networking sites (Facebook™, Orkut™, Twitter™, MySpace™), blogs, and video sharing sites (Youtube™). The reach of these social media channels is extensive and demographic of users accessing these social media channels is very diverse. The social media channels have access to a huge customer base and thus various companies and organizations try to aggressively utilize it to market their products, brands, and services.

The data that can be mined from these social media channels regarding access patterns of users is very useful for performing market intelligence. Using this data, marketers plan and manage their promotional campaigns on social media channels. However, the use of this data to design marketing campaigns in many conventional methods is a manual process, and thus has inconsistent and unpredictable results.

Some conventional systems use tools for extracting and analyzing this data to design social media campaigns. However, these tools are not very efficient and precise either in extracting the data or in performing analytics on the data. Thus they are not able to design directed and successful marketing campaigns.

There is therefore a need for a method and system which use efficient techniques for extracting data from social media channels and for analyzing this data, such that, the result of these analytics can be used to design successful marketing campaigns.

### SUMMARY OF THE INVENTION

In view of the foregoing disadvantages inherent in the known types of social media campaigns now present in the prior art, the present invention provides an improved system and method for designing and managing social media campaigns, and overcomes the above-mentioned disadvantages and drawbacks of the prior art. As such, the general purpose of the present invention, which will be described subsequently in greater detail, is to provide a new and improved system for designing and managing social media campaigns and method which has all the advantages of the prior art mentioned heretofore and many novel features that result in a system and method for designing and managing social media campaigns which is not anticipated, rendered obvious, suggested, or even implied by the prior art, either alone or in any combination thereof.

In one embodiment, a system for designing and managing one or more social media campaigns is provided. The system comprises a demand side configured to be accessed by a marketer, a supply side configured to be accessed by one or more social media channels and a social media exchange platform configured to enable exchange of data between the demand side and the supply side.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

In another embodiment, the system for designing and managing one or more social media campaigns comprises at least one client capable of providing a user, access to a plurality of social media channels and a server communicatively coupled to the at least one client through a network, the server configured to extract user information from the at least one client, a demand side configured to be accessed by a marketer, a supply side configured to be accessed by the plurality of social media channels and a social media exchange platform configured to enable exchange of data between the demand side and the supply side.

In yet another embodiment, a method for designing and managing a social media campaign is provided. The method comprises steps of sourcing desired data for designing the social media campaign, computing one or more social media indices for at least one of a product, a brand and a service, based on the sourced data, performing analysis of the social media indices in order to determine strategies for designing the social media campaign and managing the social media campaign for one or more social media channels.

Still another object of the present invention is to provide a system and method for designing and managing social media campaigns that provides in the apparatuses and methods of the prior art some of the advantages thereof, while simultaneously overcoming some of the disadvantages normally associated therewith.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages.

FIG. 1 illustrates an exemplary environment in which various embodiments of the invention may function;

FIG. 2 shows a block diagram of a system for designing and managing social media campaigns, in accordance with an embodiment;

FIG. 3 illustrates a flow chart depicting a method for designing and managing social media campaigns, as described in an embodiment; and

FIG. 4 illustrates a flow chart depicting the step of managing social media campaigns shown in FIG. 3, as described in an embodiment.

### DETAILED DESCRIPTION OF THE INVENTION

Before describing in detail embodiments, it should be observed that the embodiments reside primarily in combinations of method steps and system components related methods and systems for managing social media campaigns. Accordingly, the system components and method steps have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions.

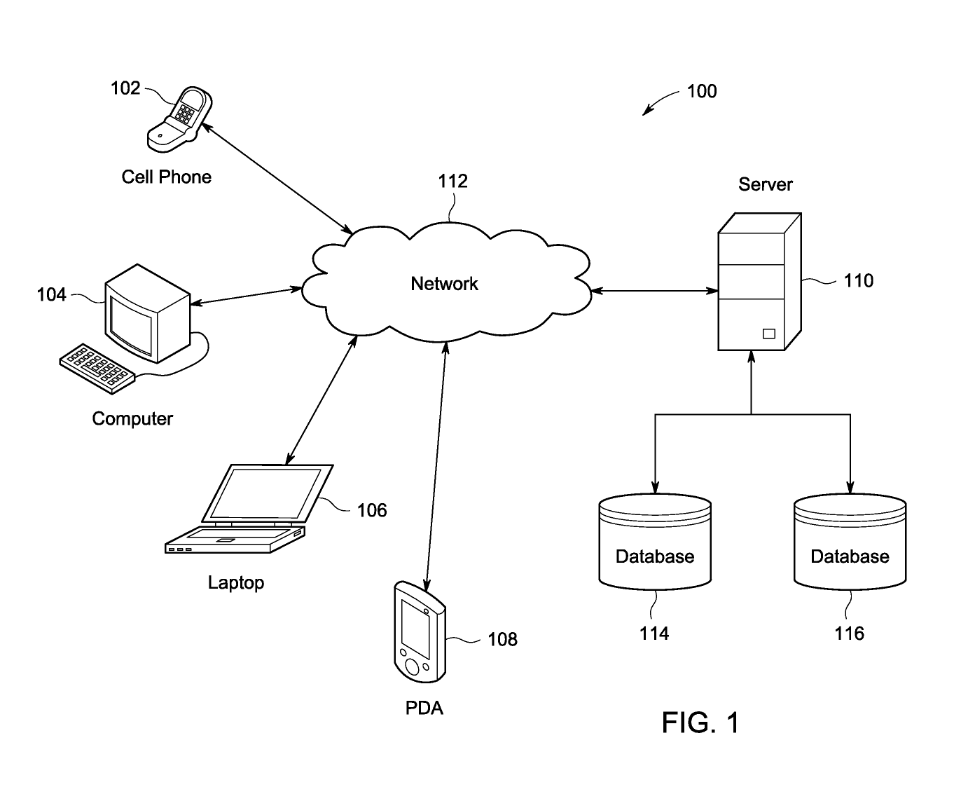

FIG. 1 illustrates an exemplary environment 100 in which various embodiments of the invention may function. Environment 100 includes one or more clients (for example, a client 102, a client 104, a client 106, and a client 108) and a server 110. Example of the one or more clients may include, but are not limited to, a computer, a laptop, a Personal Digital Assistant (PDA), a mobile phone, and a smart phone. The one or more clients may communicate with server 110 through a network 112. Network 112 may be a wired or a wireless network.

The one or more clients may communicate with server 110 to request some information. To provide this information, server 110 may further communicate with one or more databases (for example, a database 114 and a database 116) to extract data and perform proprietary analytics on the data. In another scenario, server 110 may initiate communication with the one or more clients to extract some information and store it on the one or more databases. The information may include, but is not limited to, applications and services used on a client, websites visited on the client, and information related to users of the client.

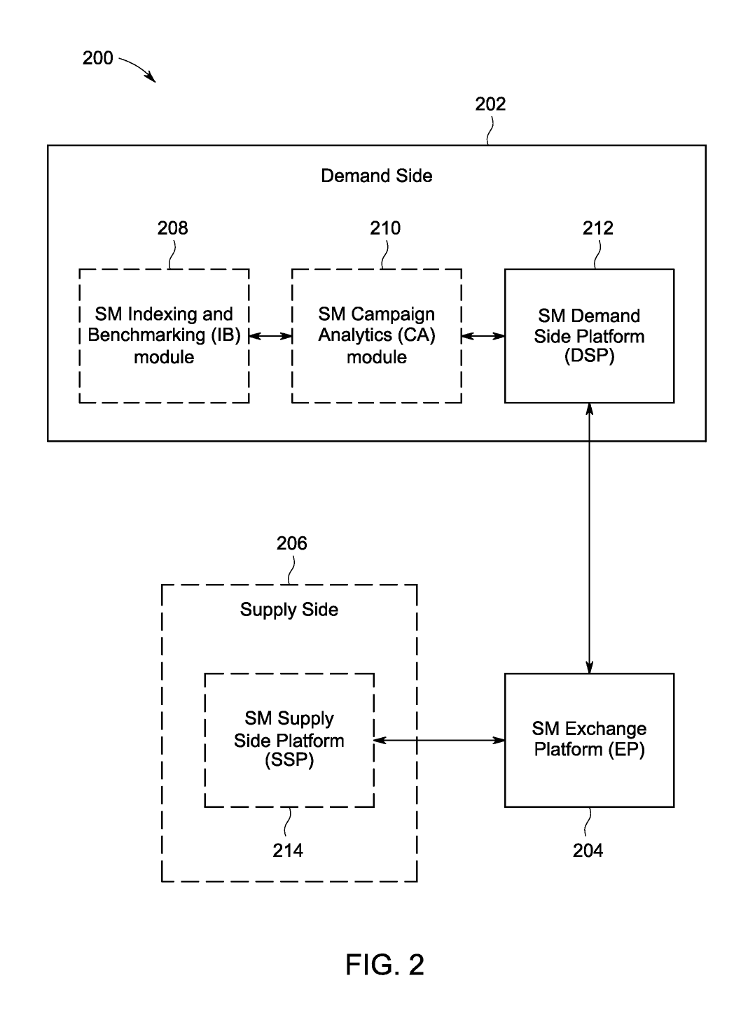

FIG. 2 is a block diagram of a system 200 for designing and managing social media campaigns, in accordance with an embodiment. System 200 includes a demand side 202, which is accessed by a marketer, and a supply side 206, which is accessed by social media channels. Social media channels are channels that encourage social gathering and interaction in online space. Social media channels may be web or mobile based. Examples of social media channels may include, but are not limited to, blogs, Facebook™, Orkut™, Twitter™, MySpace™, and Youtube™. System 200 also includes a social media Exchange Platform (EP) 204 that enables exchange of data related to social media and market campaigns between demand side 202 and supply side 206.

Demand side 202 includes a social media Indexing and Benchmarking (IB) module 208, a social media Campaign Analytics (CA) module 210, and a social media Demand Side Platform (DSP) 212. Each of Social media IB module 208, social media CA module 210, and social media DSP 212 may reside on server 110. In this case, the one or more clients access social media DSP module 212 through network 112 using a thin client. In an embodiment, social media DSP 212 may reside on the one or more clients as a thick client.

Social media IB module 208 sources data required for designing social media campaigns from social media channels. Further, social media IB module 202 organizes and stores this data in the one or more databases 114 and 116. This data is used to compute social media indices for a product, brand, or a service. These indices easily enable a user to identify relative position of the product, brand, or service when compared to competitors and thus benchmark them. Social media CA module 210 uses these social media indices and performs additional analytics on the data stored in the one or more databases 114 and 116. Through these analytics, social media CA module 210 suggests strategies and tactics for designing social media campaigns that get positive response from audience. Social media CA module 210 is explained in detail in a related application filed concurrently with the present application.

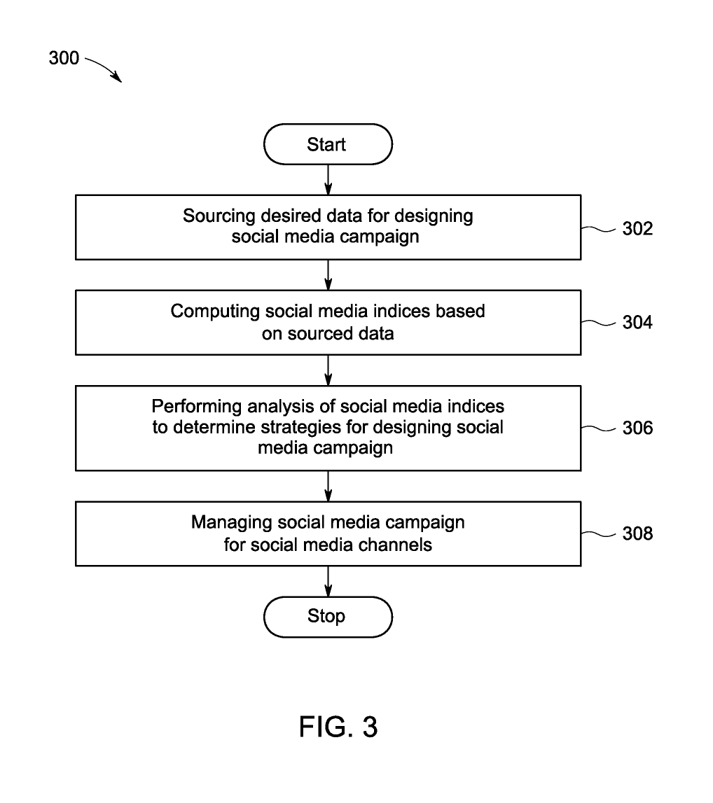

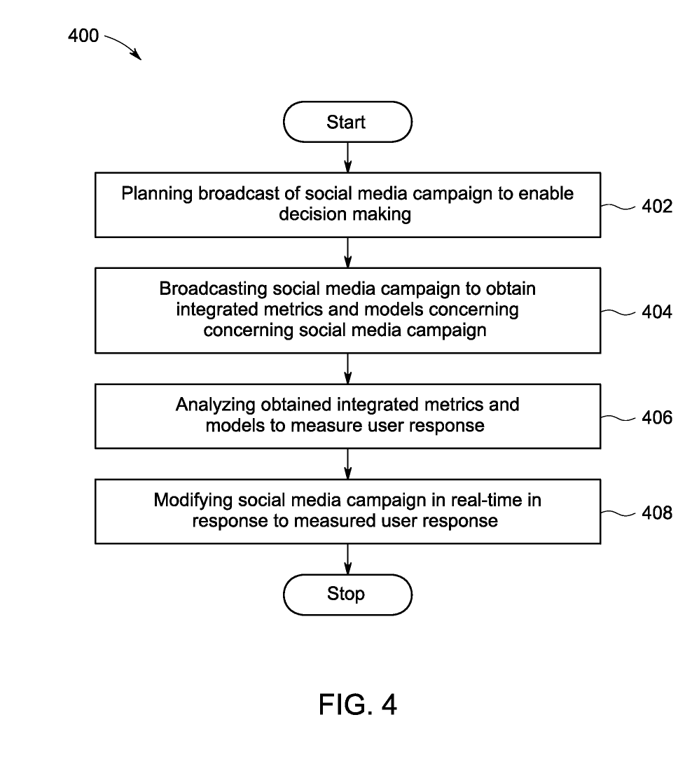

The social media campaign thus designed is managed by social media DSP 212 for various social media channels. In certain embodiments, the campaign management or assistance is done in real-time and in a centralized manner. The real-time campaign assistance and management is explained in detail in conjunction with FIGS. 3 and 4.

FIG. 3 shows a method 300 for designing and managing the social media campaigns. The method 300 comprises sourcing desired data for designing the social media campaign at step 302, computing one or more social media indices for at least one of a product, a brand and a service, based on the sourced data at step 304, performing analysis of the social media indices in order to determine strategies for designing the social media campaign at step 306 and managing the social media campaign for one or more social media channels at step 308. The step of managing the social media campaign is further explained in conjunction with FIG. 4.

Accordingly, FIG. 4 shows a method 400 of managing the social media campaign. The method 400 comprises steps of planning a broadcast of the social media campaign so as to enable decision making on one or more items at step 402, broadcasting the social media campaign in order to obtain one or more integrated metrics and models concerning the social media campaign at step 404, analyzing the obtained integrated metrics and models to measure user response at step 406 and modifying the social media campaign in real-time in response to the measured user response for enhancing the effectiveness of the social media campaign at step 408.

Social media DSP 212 runs social media campaigns at marketer's end and provides integrated campaign metrics, models, and insights. Additionally, it has tools for planning the campaign and enabling decision making on the pricing. Social media DSP 212 also has tools for performing analytics that help in gauging and measuring user response to the campaign being run. This again has been explained in detail in conjunction with FIGS. 3 and 4. Based on this, social media DSP 212 may modify the campaign in real-time to improve the effectiveness of the campaign.

Referring back to FIG. 2, social media DSP 212 also communicates with social media EP 204 to facilitate trading and bidding of social media inventories. In certain embodiments, the trading or bidding may be done in real-time. As noted above, the social media EP 204 is in communication with supply side 206 to enable the trading and bidding of social media inventories. For this purpose, supply side 206 may include a social media supply side platform (SSP) 214 that is quite similar in function and capabilities to its demand side counterpart social media DSP 212. Thus, the social media EP 204 communicates with social media supply side platform (SSP) 214 to enable real time trading or bidding of social media inventories. It should be noted that the social media EP 204 may reside either on demand side 202 or supply side 206 or may exist separately as a third party.

Using social media DSP 212 and social media EP 206, marketers and suppliers can flexibly manage a dynamically changing social media environment. This may also enable disintermediation, as all the intermediaries between the marketers and the actual campaign disappear.

The method and systems for managing social media campaigns as described herein or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method.

The computing device executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the computing device to perform specific tasks such as the steps that constitute the method. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the computing device may be in response to user commands, or in response to results of previous processing or in response to a request made by another computing device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

While embodiments of the system and method for designing and managing social media campaigns have been described in detail, it should be apparent that modifications and variations thereto are possible, all of which fall within the true spirit and scope of the invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for designing and managing one or more social media campaigns, the system comprising:
at least one client capable of providing a user access to plurality of social media channels;
a server communicatively coupled to the at least one client through a network, the server configured to extract user information from the at least one client;
a demand side configured to be accessed by a marketer;
a supply side configured to be accessed by the social media channels; and
a social media exchange platform configured to enable exchange of data between the demand side and the supply side.

2. The system of claim 1, wherein the demand side comprises:
a social media indexing and benchmarking module configured to source desired data for designing a social media campaign and compute one or more social media indices for at least one of a product, a brand and a service, based on the sourced data;
a social media campaign analytics module configured to perform analysis of the social media indices in order to determine strategies for designing the social media campaign; and
a social media demand side platform configured to manage the social media campaign for the social media channels.

3. The system of claim 2, wherein at least one of the social media indexing and benchmarking module, the social media campaign analytics module and the social media demand side platform reside on the server.

4. The system of claim 2, wherein the social media demand side platform resides on the at least one client.

5. The system of claim 1, wherein the user information comprises a list of one or more applications used by the user, a list of one or more services employed by the user, a list of one or more websites accessed by the user and information related to the user of the at least one client.

6. The system of claim 2, wherein the social media indexing and benchmarking module is configured to source desired data for designing the social media campaign from at least one of the social media channels and the at least one client.

7. The system of claim 2, wherein the social media demand side platform is further configured to plan a broadcast of the social media campaign so as to enable decision making on one or more items.

8. The system of claim 7, wherein the social media demand side platform is further configured to broadcast the social media campaign in order to obtain one or more integrated metrics and models concerning the social media campaign.

9. The system of claim 8, wherein the social media demand side platform is further configured to perform analysis of the obtained integrated metrics and models to measure user response, subsequent to the broadcast of the social media campaign.

10. The system of claim 9, wherein the social media demand side platform is further configured to modify the social media campaign in real-time in response to the measured user response for enhancing the effectiveness of the social media campaign.

11. The system of claim 2, wherein the social media demand side platform is further configured to communicate with the social media exchange platform to facilitate trading and bidding of one or more social media inventories and wherein the trading and bidding is performed in real-time.

12. The system of claim 1, wherein the supply side comprises a social media supply side platform configured to communicate with the social media exchange platform to facilitate trading and bidding of one or more social media inventories and wherein the trading and bidding is performed in real-time.

13. A system for designing and managing one or more social media campaigns, the system comprising:
a demand side configured to be accessed by a marketer;
a supply side configured to be accessed by one or more social media channels; and
a social media exchange platform configured to enable exchange of data between the demand side and the supply side.

14. The system of claim 13, further comprising:
at least one client capable of providing a user, access to multiple social media channels; and
a server communicatively coupled to the at least one client through a network, the server configured to extract user information from the at least one client.

15. The system of claim 13, wherein the social media exchange platform is a part of one of the demand side and the supply side.

16. The system of claim 13, wherein the demand side comprises:
a social media indexing and benchmarking module configured to source desired data for designing a social media campaign and based on the desired data compute a social media indices for at least one of a product, a brand and a service;
a social media campaign analytics module configured to perform analysis of the social media indices in order to determine strategies for designing the social media campaign; and
a social media demand side platform configured to manage the social media campaign for the social media channels.

17. The system of claim 16, wherein the social media indexing and benchmarking module is configured to source desired data for designing the social media campaign from at least one of the social media channels and the at least one client.

18. A method for designing and managing a social media campaign, the method comprising the steps of:
sourcing desired data for designing the social media campaign;
computing one or more social media indices for at least one of a product, a brand and a service, based on the sourced data;
performing analysis of the social media indices in order to determine strategies for designing the social media campaign; and
managing the social media campaign for one or more social media channels.

19. The method of claim 18, further comprising steps of:
planning a broadcast of the social media campaign so as to enable decision making on one or more items;
broadcasting the social media campaign in order to obtain one or more integrated metrics and models concerning the social media campaign;
analyzing the obtained integrated metrics and models to measure user response; and
modifying the social media campaign in real-time in response to the measured user response for enhancing the effectiveness of the social media campaign.

20. The method of claim 19, further comprising facilitating trading and bidding of one or more social media inventories, the trading and bidding being performed in real-time.
